(19) United States
(12) Patent Application Publication
(10) Pub. No.: US 2010/0332465 A1
(43) Pub. Date: Dec. 30, 2010

(54) Method and system for monitoring online media and dynamically charting the results to facilitate human pattern detection

(76) Inventors: Frizo Janssens, Mortsel (BE); Per Siljubergsasen, Brussels (BE)

Correspondence Address: ELLIOT FURMAN, 15 WEST 81ST STREET #11J, NEW YORK, NY, 10024, US

(21) Appl. No.: 12/639,022

(22) Filed: Dec. 16, 2009

Related U.S. Application Data
(60) Provisional application No. 61/138,073, filed on Dec. 16, 2008.
(60) Provisional application No. 61/175,757, filed on May 5, 2009.

(51) Int. Cl. G06F 17/30

(52) U.S. Cl. 707/722; 707/E17.014

(57) ABSTRACT

A time frame is specified. A search engine is queried for concepts within the time frame. The similarity and distances between concepts is calculated, and the graph coordinates of the concepts are computed. The search engine is queried for more time frames, and similarity, distances, and coordinates calculated for the concepts for each time frame. Consecutive time frames are mapped onto each other. A dynamic chart of the relationships between the concepts and how they evolve over the time frames is generated.

This application claims the benefit of U.S. Provisional Application No. 61/138,073, filed Dec. 16, 2008, and U.S. Provisional Application No. 61/175,757, filed May 5, 2009, both of which are hereby incorporated by reference.

### BACKGROUND

Companies like Twitter and Facebook and other social media such as blogs, microblogs, forums, commenting systems, video sites, and the like offer a huge opportunity for professionals such as marketers, advertisers, and public relations specialists to better understand how their products, brands, and topics are perceived by the public, and how they can better position their products, brands, topics based on the public perception.

Professionals might want to know brands and topics that are discussed online together, as well as their evolution, and to identify why certain brands and topics are related. This is important since brand value and future sales may be strongly impacted by customers' and consumers' perceptions. Is the perception of a brand in-line with the brand owner's goal? What do consumers see as competing, alternative products?

Market research companies have traditionally relied on manual collation of this type of information via focus groups and consumer sampling. Social media, however, offers the dream of obtaining this information in a more timely and automatic manner. But, there is a never-ending and constantly changing supply of “conversational” social media data, making it is extremely difficult, if not impossible, for professionals to accurately assess, in a timely manner, which conversations are of value, how they are interrelated, and how they relate to the professionals' product, brand, or topic.

Thus, a need presently exists for a method and system for monitoring online media and dynamically charting the results to facilitate human pattern detection.

### SUMMARY

A method for monitoring online media and charting the results to facilitate human pattern detection comprises specifying a time frame. A search engine is queried for concepts within the time frame. Similarity and distances between the concepts is calculated. In calculating the similarity and distances, a distance matrix is calculated. Graph coordinates of the concepts are computed from at least part of the distance matrix. The querying, calculating the similarity and distances, and computing graph coordinates is repeated for at least one more time frame. Consecutive time frames are mapped onto each other. A dynamic chart of the relationships between the concepts and how they evolve over the time frames is generated. A computer program product comprises a computer readable medium including a computer readable program, wherein the computer readable program when executed on a computer causes the computer to carry out the method for monitoring online media and charting the results to facilitate human pattern detection.

### BRIEF DESCRIPTION OF THE DRAWINGS

FIG. 1 shows the data, algorithm, and visualization layers of a system for monitoring online media and charting the results to facilitate human pattern detection.

FIG. 2 illustrates a symmetric co-reference matrix with buzz, restricted buzz and (restricted) co-reference numbers for calculating the similarity and distances between concepts.

FIG. 3 shows an input for a multidimensional scaling algorithm for calculating the graph coordinates of concepts.

FIG. 4 shows an input for a principal component analysis algorithm for calculating the graph coordinates of concepts.

FIG. 5 shows an exemplary output of a multidimensional scaling algorithm, principal component analysis algorithm, and a correspondence analysis algorithm.

FIG. 6 is a mock-up of a Brand Map chart.

FIG. 7 is a screenshot of an exemplary Brand Map charts.

FIG. 8 shows an exemplary architecture of the system of FIG. 1.

FIG. 9 shows a method for monitoring online media and charting the results to facilitate human pattern detection.

### DETAILED DESCRIPTION

I. Introduction

Brand Maps (BMs) measure and visualize the evolution of perceived associations or relatedness between (possibly multiple types of) concepts (e.g., “entities” and “topics” will be used throughout this document). Entities can be brands, products, organizations, people, etc, while topics can be events, features, etc. Entities/topics can be either predefined or automatically detected. The result is a temporal visualization of large amounts of data and high-dimensional distances based on large-scale data sets, facilitating human pattern detection. BMs can be generated for any type of digital data having a temporal aspect (timestamps): blogs, forums, news, data sets with scientific articles, patent data sets, corporate data sets, etc.

Part of the commercial value of BMs lies in the possibility for users to identify brands and topics that are discussed online together, as well as their evolution, and to identify why certain brands and topics are related. This is important since brand value and future sales are strongly impacted by customers' and their perceptions. Is the perception of a brand in line with brand owners' goals? What do consumers see as competing/alternative products?

Feedback from BMs provides a basis for improving and adjusting marketing campaigns, to maintain brand reputation, discover new insights and emerging trends, conversational/word-of-mouth marketing, and the like.

II. Terminology

Concept: anything that can be described by a query (for example, comprising keywords and Boolean operators) that can be executed in a search engine. Multiple types/categories of concepts are possible. Throughout this document two categories “entities” and “topics” will be used

Example entity: (“Barack Obama” OR (obama AND (president OR senator)))

Example topic: (iraq OR iraqi OR escalation OR ((“middle east” OR este) AND (crisis OR guerra OR war)))

Scope: a clause that is conjunctively added to every concept's query to include or exclude certain contexts.

“Buzz” of a concept: Aggregate number of online articles collected containing pre-selected terms related to the concept. It is the total number of documents that are returned in the search result satisfying the concept's query.

Article or document: unit of buzz. An individual sentence or post, usually a writing sample, e.g. a blog entry, a forum post, or a news article.

“Restricted buzz” of a concept: the buzz of a concept that is restricted to also co-occur with any concept of another category. Currently only used for “topic” concepts. For example, the restricted buzz of a topic is the number of documents in the collection that satisfy the conjunctive query consisting of the topic's query AND a disjunction of all entity queries. It will return the number of documents that contain the topic concept and at least one of the entity concepts.

Number of co-references: Co-reference numbers count the number of documents in a certain collection that refer to each concept or a certain pair of concepts. The concepts are said to “co-occur” in those documents. In practice, the number of co-references of two concepts can be the number of documents that are returned by a search engine in response to a conjunction of the queries of both concepts.

Restricted number of co-references: Number of times that a pair of concepts both co-occur with at least one concept of another category.

Co-reference matrix: a matrix containing the co-reference numbers cᵢⱼ, i.e., the number of documents in which concepts i and j co-occur.

III. Overview of the BM System

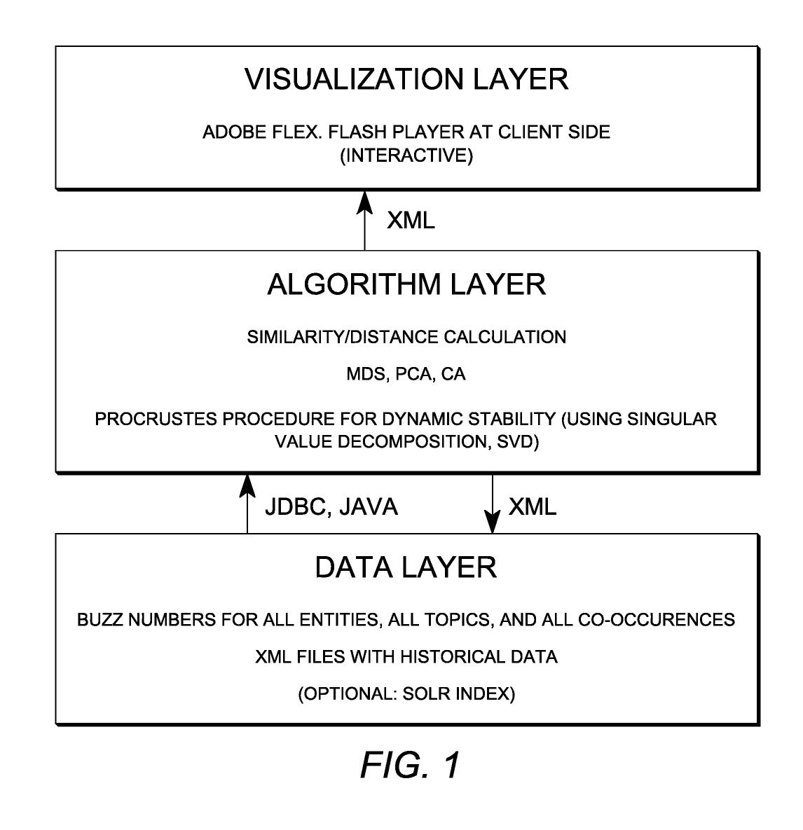

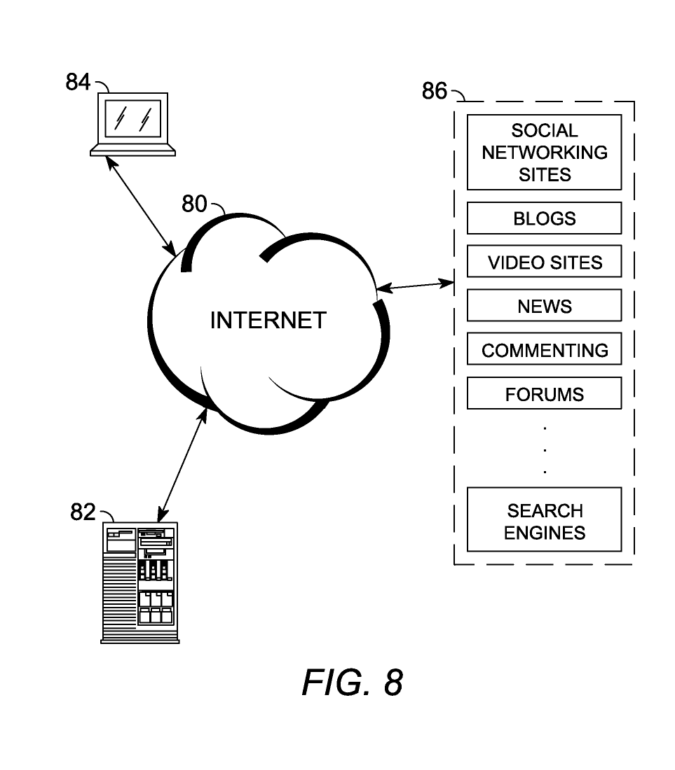

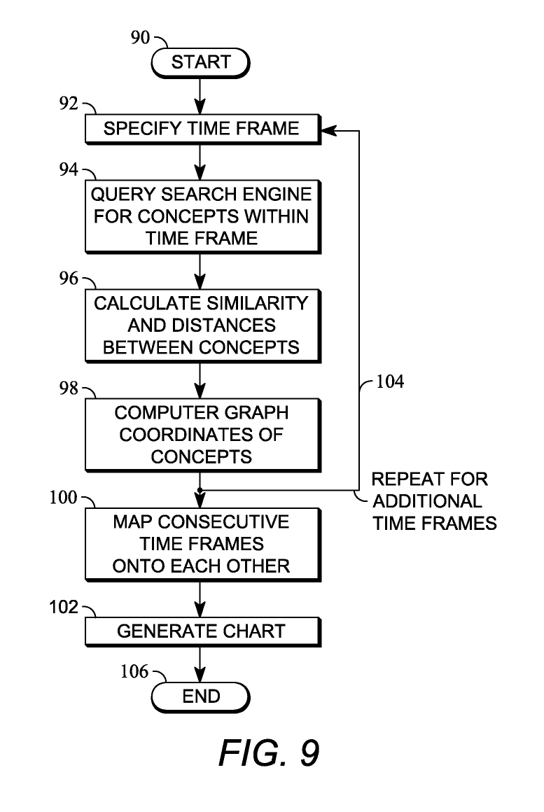

FIG. 1 shows the data, algorithm, and visualization layers of the system. FIG. 8 shows an exemplary architecture for the system of FIG. 1. The architecture includes a server 82 connected to a network 80, such as the internet. At least one client 84 is connected to the network 80 and in communication with the server 82. A plurality of data sources 86 are also in communication with network. FIG. 9 shows a method for monitoring online media and charting the results to facilitate human pattern detection.

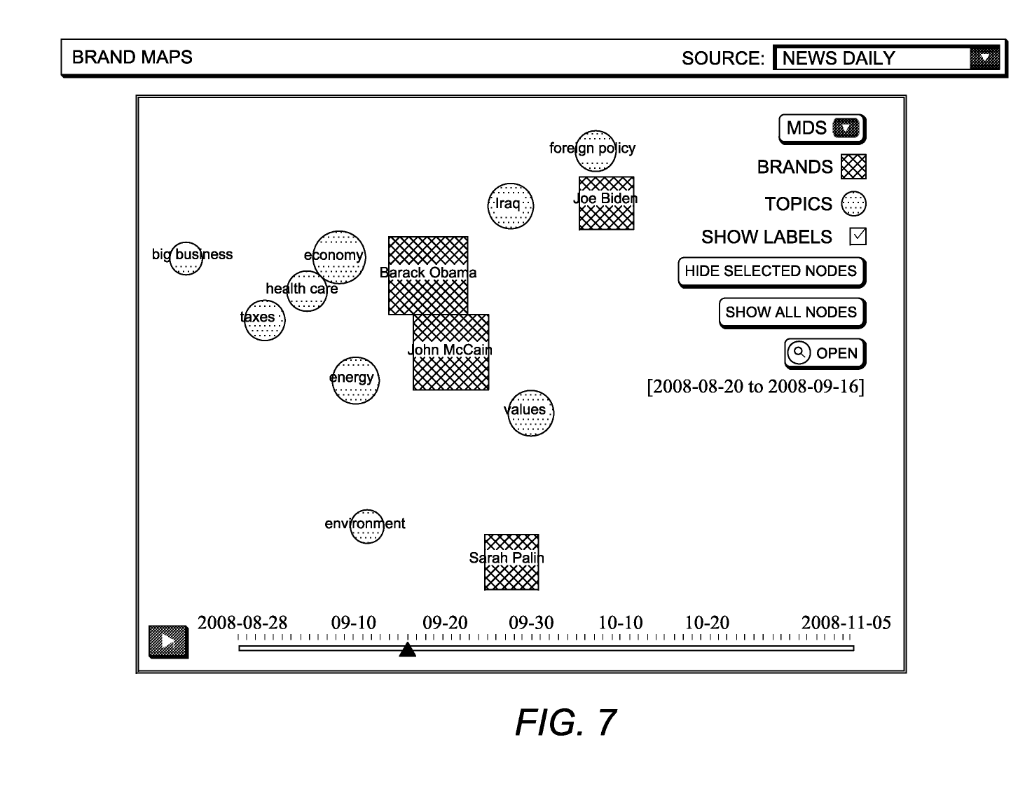

Briefly, server 82, which functions in part as a search engine, searches one or more of the plurality of data sources 86 for concepts within a time frame (steps 92 and 94 of FIG. 9). Calculations are performed on the results of the search to determine the similarity and distances between the concepts (96 of FIG. 9), and to compute graph coordinates of the concepts (98 of FIG. 9). The search engine 82 is queried again for additional concepts in different time frames (104 of FIG. 9). Then, consecutive time frames are mapped onto each other in order to ensure stability of a dynamic chart (100 of FIG. 9). Finally, a dynamic chart (for example, FIG. 7) is generated which displays the relationship between brands and topics and conversation online (102 of FIG. 9).

The chart is displayed at client computer 84. This chart provides a view of a topic's or brand's online conversational universe and makes it possible to identify brands and topics that are discussed online together, as well as their evolution, and to identify why certain brands and topics are related (also see “Attentio Brand Maps,” Frizo Janssens, Proceedings of the Third International ICWSM Conference (2009), which is hereby incorporated by reference).

Computations may be initiated by the client 84 instead of being pre-calculated by the server 82, allowing flexible sub-selections of computational options made by the client. For server-side computations, a buffering system could be used to incrementally load the data.

Client 84 may comprise any type of computer, including mobile devices such as cell phones, smart phones, PDAs, portable computers, and any other type of mobile device operable to transmit and receive electronic messages. The network 80 may include the Internet and wireless networks such as a mobile phone network. Computers 82 and 84 may be one or more computers and may comprise any type of computer capable of storing computer executable code and executing the computer executable code on a microprocessor, and communicating with the communication network 80.

The disclosed systems and methods, and modification thereof may be implemented on any conventional computer using any array of widely available and well understood software platforms, programs, and programming languages. For example the systems and methods may be implemented on an Intel or Intel compatible based computer running a version of the Linux operating system or running a version of Microsoft Windows. The computers may include any and all components of a computer such as storage like memory and magnetic storage, interfaces like network interfaces, and microprocessors. Programs, programming languages, APIs, and the like may be used such as Java, Java Database Connectivity (JDBC), Adobe Flex, and Adobe Flash, such as shown in FIG. 1. Addendum 3 shows an exemplary XML schema for storing and transferring chart data.

The server 82 may include a database and an Apache web server. The database may be any conventional database such as an Oracle database or an SQL database. The server may include a search platform such as Solr. These components of the computer, including creating, storing, modifying, and querying databases, and interfacing and communicating with networks are well understood by those having ordinary skill in the art.

FIG. 9 shows a method for method for monitoring online media and charting the results to facilitate human pattern detection. A computer program product may include a computer readable medium comprising computer readable code which when executed on the computer causes the computer to perform the methods described herein. Some or all of the computer readable code, which includes the data, algorithm, and visualization layers of FIG. 1 and the method of FIG. 9, may be executed on the processor of server 82 and client computer 84.

IV. Input for BMs

The similarity and distances between concepts is calculated and a distance matrix is created. In one example, per source and per region (or other demographics), a square, symmetric “co-references matrix” with co-reference numbers between concepts is computed. As will be disclosed below, depending on the algorithm used to compute the similarities and distances, the co-reference numbers between concepts may be between one, or any combination of the following: between entities-topics, topics-topics, and entities-entities.

For two identical concepts, the number of co-references (a value on the diagonal in the co-references matrix) is taken equal to the total number of documents in the collection that contain that concept (i.e., the “buzz” or “restricted buzz” of the concept). The size of the co-references matrix is k×k, with k the total number of concepts (number of entities m+number of topics n). Because the matrix is symmetric, the upper (or lower) triangular part together with the diagonal contain all needed information.

BMs may or may not aggregate multiple hours or days of data in each time frame (‘moving window’), whether or not the aggregation is ‘overlapping’.

V. Algorithms

The positions (coordinates) of concept representations on a BM can be computed by various algorithms. These coordinates are 2- or 3-D approximations that are optimal in mathematical/statistical sense. Three exemplary algorithms are:

1) Multidimensional Scaling (MDS)

2) Principal Component Analysis (PCA)

3) Correspondence Analysis (CA)

It is appreciated that these are not the only algorithms that may be used. The distance matrix may be computed from any other distance or similarity function between concepts. For example, text based cosine similarity between term-document vectors may be used. Accordingly, buzz and co-reference numbers are not specifically required since any similarity or distance relationship between concepts can be used. For example, distances may be calculated by text mining, based on hyperlink information, and the like. The matrix is not necessarily square and symmetric, and the distance function does not need to be symmetric. In the example with co-reference numbers it is symmetric.

V.1 Multidimensional Scaling (MDS)

MDS presents the concepts (e.g., entities and topics) in a 2D or 3D space such that the pairwise distances approximate the buzz-based distances as precisely as possible. Highly co-referenced concepts in general are placed close to each other on an MDS BM.

Multiple MDS algorithms exist. One type is “Classical, metric MDS”, which includes advantages such as:

It gives an analytical solution requiring no iteration

It gives a nested solution (2D-3D- . . . )

“metric MDS is more robust in numerical sense; more likely to yield global optimum”

Input

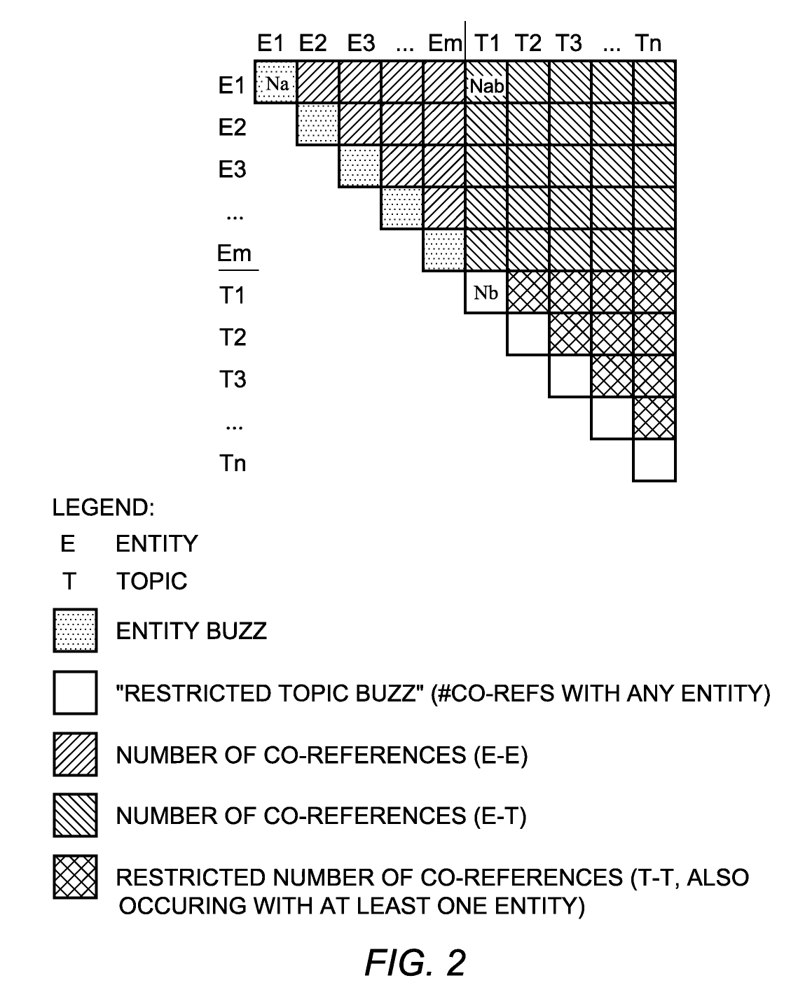

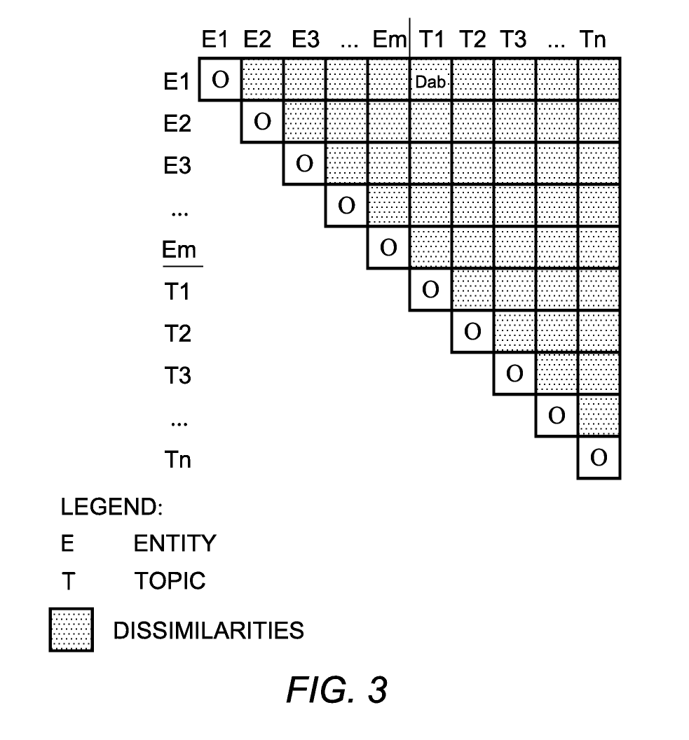

The input for an MDS algorithm is a square, symmetric dissimilarity (distance) matrix (see FIG. 3). This k×k dissimilarity matrix is calculated from the (restricted) buzz and co-reference numbers in the co-reference matrix (see FIG. 2) by, for example, applying the following formula,

$$dist ( a , b ) = Dab = 1 - ( \frac{Nab}{1 + 2 * Na} + \frac{Nab}{1 + 2 * Nb} ) \qquad ( 1 )$$

with Na and Nb the respective (restricted) buzz (values on diagonal), and Nab the co-occurrence frequency (off-diagonal values). (The ‘1+’ in the denominator down-weights a bit cases like 1=Nab=N a=Nb (i.e., if both brands occur only once, their similarity should not be 100%)).

Short Description of the MDS Algorithm (Also See [1] in Addendum 2)

Output

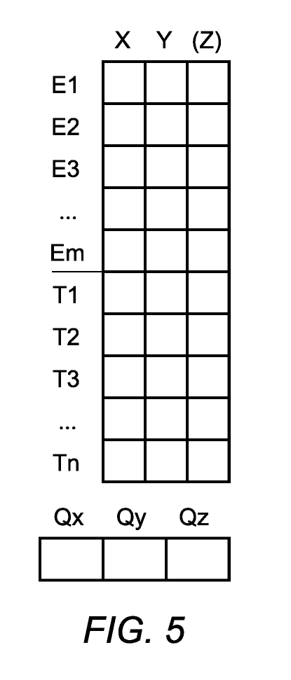

The output of an MDS algorithm is a (k-by-1) configuration matrix containing the coordinates of concept representations. If the dissimilarity matrix (see FIG. 3) would be a Euclidean distance matrix, then 1 would be the dimension of the smallest space in which the k points can be embedded. In the case of BM, however, the matrix is a more general dissimilarity matrix and 1 is the number of positive eigenvalues of the matrix. For displaying the BM charts in two or three dimensions, only the first two or three coordinates (out of 1) are retained (see FIG. 5). Consequently, a BM is an approximation of the configuration of points that is optimal in mathematical sense.

V.1.1 Centric MDS

To compute a “centric MDS”, which has a focal concept in the center, a one-dimensional MDS is calculated with all concept representations except for the centered one, which is left out. The result is a straight line of concept representations. Largest distance is between those on opposite sites of the line. Next, the line is “projected” on the unit circle (radius=1) around the centric concept in the following manner,

dMax=max(mdsCoords)−min(mdsCoords);

scale=dMax/(2*pi−pi/3);

posOnCirc=mdsCoords/scale;

posOnCirc=posOnCirc−min(posOnCirc);

angles=pi/3−posOnCirc;

centricCoordinates [cos(angles), sin(angles)];

where mdsCoords contains the ordinate values of all concepts on the line and centricCoordinates will contain the X- and Y-coordinates of the non-centric concepts, lying on the unit circle around the centric concept.

Each concept representation (b) on the unit circle is then pulled towards the center according to the number of co-references with the centric concept (a). An exponential multiplier is applied to the coordinates to pull concept (b) towards the centric concept; the x- and y-coordinates are multiplied by:

$$exp ( \frac{- 3 \cdot {N}_{ab}}{min ( ( {\sum }_{c} {N}_{a c} ) , {N}_{a} )} ) \qquad ( 2 )$$

where Na is the buzz of the centered concept (a), Nab is the number of co-references the centric concept (a) has with the non-centric one (b), and Σ_{c}N_{ac} is the sum of all co-references of any concept (c) with the centric one (a).

Examples:

If there are no co-references, then the non-centric concept representation is on the unit circle (exp(0)=1).

If the number of co-references is maximal (Nab=Na), then the bubble is almost in the center. (exp(−3)=0,05).

V.2 Principal Component Analysis (PCA)

PCA gives the dimensions (axes) that explain most of the variance in the data by calculating the eigenvalue decomposition of the covariance matrix of an object-by-variable matrix. The resulting principal components are orthogonal linear combinations of the original ‘variables’ (columns).

Input

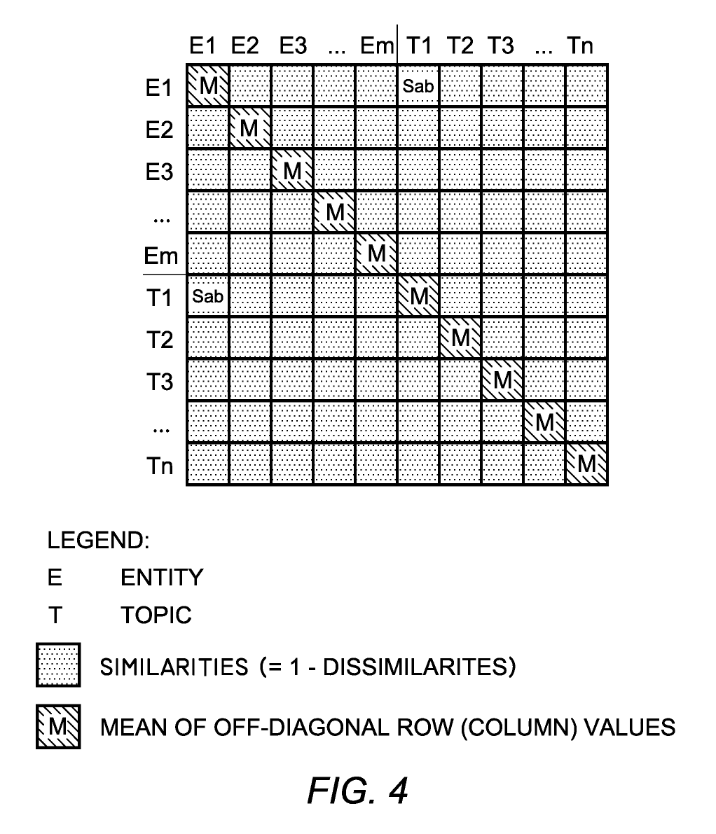

The matrix in FIG. 4 is the complement of the dissimilarity matrix of FIG. 3 (Sab=1−Dab), completed with both the upper and lower triangular part. The values on the diagonal are set to the mean of the off-diagonal values on the corresponding row or column. The similarity/proximity/affinity matrix is first standardized and then passed as input to the PCA algorithm, where it is considered as an object-by-variable matrix.

Short Description of the PCA Algorithm (Also See Addendum 2)

Output

The “principal component scores” provide the representation of the data in the space spanned by the principal components, i.e., the coordinates of which again only the first two or three are withheld (see FIG. 5).

V.3 Correspondence Analysis (CA)

CA is a weighted form of PCA that is appropriate for frequency data of 2 categorical variables. To compute BMs using CA (Unlike MDS and PCA), only the co-reference counts between entities and topics are needed (gray region in FIG. 2, left). Hence, a frequency or contingency table listing all co-occurrence frequencies of entity-by-topic pairs suffices to calculate positions of concepts on the charts, reducing the number of queries needed and thus the computational complexity. However, the buzz values on the diagonal of the co-references matrix are needed in order to determine the “bubble sizes” of the concepts on the charts; and the entity-entity (blue region) and topic-topic (yellow) pairs are useful information to show on the chart when requested (see Section VI). If less than two rows or less than two columns remain in the contingency table, then the CA map is not generated.

V.5 Stability of BMs Over Time

In order to ensure stability of the dynamic charts over time, consecutive time frames are mapped onto each other in a mathematical optimal way. Depending on the algorithm used to compute the BM, this optimal mapping may be achieved by different algorithms. In case of MDS, the temporal mapping is done by the “Procrustes procedure” (also see [1] of Addendum 2): the chart of time t2 is mapped on the chart of time t1 by minimizing (in least-squares sense) allowed transformations: rotations, reflections, and dilations. For PCA and CA only reflections are allowed; the optimal reflection out of 4 possibilities (change of sign of X and/or Y axes) is calculated in least-squares sense. Centric MDS maps only consider a change of the sign of X.

Matrix Algebra Behind the Procrustes Procedure

[U,S,V]=singular_value_decomposition (coordinates_t1′*coordinates_t2) optimal_coordinates_t2=coordinates_t2*V*U′

V.6 Additional Remarks

In one embodiment, the calculations are done server-side. In another embodiment, the similarity/distance information is transferred from the server to the client, while concept positions are calculated by applying the algorithms on the client-side.

Classical MDS with (embeddable) Euclidean distances gives the same result as PCA (up to the sign). CA uses the Chi-Square distance as a dissimilarity measure, whereas MDS can accept any (dis)similarity measure.

VI. Visualization Engine

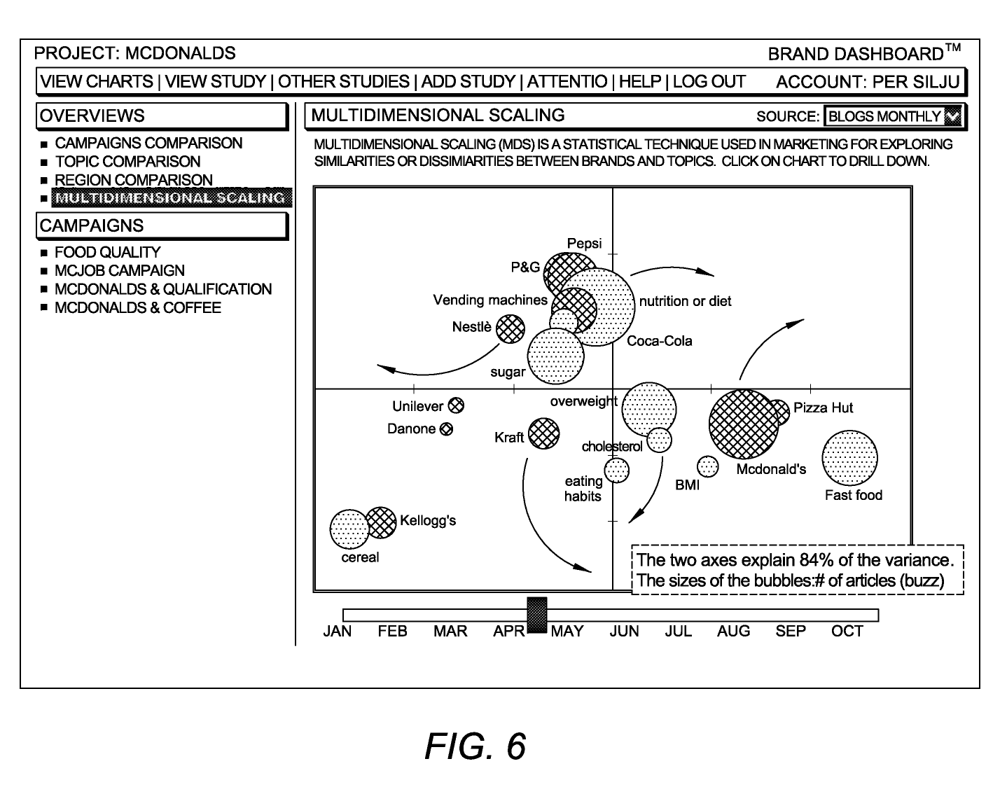

FIG. 6 is a mock-up and FIG. 7 a screenshots of Brand Map charts generated according to the above methods and systems. Some of the features and configuration options of the Brand Maps charts include.

VI.1 Features

Dimensionality

The charts can be one-, two- or three-dimensional.

Source Selection

The data source may be selected, for example “online news articles.”

Region/Demographics Selection

The region or demographics may be selected, for example by country.

Algorithm Selection

For example MDS, PCA, CA

Legend

Shows how the different concept categories (e.g., “Brands” and “Topics”) are visualized on the charts.

Size of Concept Representations

Concepts representations (e.g., the bubbles of FIGS. 6 and 7) are auto-scaled on the charts based on a linear or non-linear (e.g. sqrt, log, . . . ) function of the corresponding number of occurrences (buzz). This number of occurrences may be counted in any (sliding) time window. (e.g., one hour or day, or aggregated over multiple days, etc.). The user can also adjust the scaling factor.

Selecting Concept Representations

The user can select one or more concept representations, by either using the mouse or another pointing device to drag a rectangle around concept representations, or by clicking concepts while holding the control button in MS Windows, or the Option button on Apple Mac computers. Without holding the button, only the last clicked item remains selected. Selection can also be made by clicking one concept and holding the Shift button while clicking a second concept. All concepts residing in the implicit rectangle defined by the two selected nodes are be selected.

Non-Exhaustive List of Possible Interactions with one Selected Concept Representation

Request number of occurrences in the underlying data set ((restricted) buzz: red and green parts of FIG. 2), e.g. by hovering over the concept.

Request all information entities that can be attributed to the concept, e.g. the collection of articles that contain the concept, potentially ranked by different criteria (date, relevance, rank, etc.). These sets can be pre-computed (static) or generated on the fly (e.g., “Live search” functionality). The resulting list allows a user to browse the original information entities, offline or online.

Hide/show

Trace concept over time

Switch to centric MDS map with the selected concept representation as focal concept

Non-Exhaustive List of Possible Interactions with Two or More Selected Concept Representations

Request number of co-references in the underlying data set (blue, grey and yellow parts of FIG. 2)

Request all information entities that can be attributed to the combination of concepts, e.g. the collection of articles that contain each concept, potentially ranked by different criteria (date, relevance, rank, etc.). These sets can be pre-computed (static) or generated on the fly (e.g., “Live search” functionality). The resulting list allows to browse to the original information entities, offline or online, allowing users to drill down to individual articles that have concrete associations between certain entities/topics

Hide/show

Trace pairs of concepts over time

Hide Selected Concept Representations

The user interface allows hiding a sub-selection of concepts, whether or not leading to recalculating the positions of the remaining concepts. Currently, the selected nodes are just hidden from view, while their underlying data is still considered to define the positions of all concepts on the charts. However, it might as well trigger a re-calculation of node positions, be it either client-side or server-side.

Show All Concept Representations

Show all hidden nodes again.

Show/Hide Concept Labels

Whether the user- or automatically-defined labels for concepts are shown close to their representation. When activated, the labels are optimized in order not to overlap too much with other labels.

Interactive Timeline with Play/Pause Button

The interface may show a time slider (see sliders at bottom of FIGS. 6 and 7) that can be used interactively to go back and forth in time, and play/pause/ . . . buttons to control automatic animation. The timeline shows the current time window of data that is used to make up the current chart. The user can drag the slider to move the sliding window or start/pause the automated advancing of the time window animation. The user can also interactively adjust the speed of the automated advancing of the time window animation.

“Interpolation Effect”

When the current time frame is changed (manually or automatically), the concept representations can visually move on the chart to their new locations (updated coordinates) that are computed by the selected algorithm based on the corresponding co-reference's matrix. For example, two concepts might move closer together because they are discussed more often together.

Non-Exhaustive List of Additional Features

The user interface automatically or manually groups/annotates concepts based on common features.

The color of concept representations illustrates the overall sentiment value of underlying information units.

One or more concepts may optionally be traced on the charts by visualizing the track they follow over time.

Concepts may be added to the charts by automatic topic detection and/or named entity recognition techniques. Other concepts may disappear from the chart if they become less interesting over time, in whatever sense.

Scale Labels

The font size of the concept labels on the map (e.g., “Barack Obama”) can be auto-scaled in function of the corresponding number of occurrences (buzz).

VII. Interpreting Brand Map Charts

(Occasional reference is made to reference material of Addendum 2, and to http://faculty.chass.ncsu.edu/garson/PA765/mds.htm.)

VII.1 MDS

“While MDS assures that objects which are similar are close on the MDS map, the axes and orientation are arbitrary functions of the input data. . . . Likewise, in intuiting the meaning of dimensions, since the axes are arbitrarily oriented, it may be more interpretable to understand point location diagonally rather than vertically/horizontally.”

Horizontal and vertical axes are not to be interpreted, they have no real meaning. The only thing that matters is the pairwise distances between bubbles. Consequently, no axes are shown on BMs with MDS.

Prior knowledge about the field of interest should be used to interpret a given MDS plot. For instance, if all nodes on the MDS plot lie on a line or on a circle, or if they cluster in different groups, then you can use your expert knowledge to try to explain the reason why. Particular geometries or groupings on the plot can thus be interpreted, if you know the data.

Interpreting the MDS representation essentially means to link some of its geometric properties to known or assumed features about the brands or topics represented by the points.

It involves human interpretation of the scatter of points in specific dimensions, not necessarily the given X and Y axis. So, feel free to draw lines or curves on an MDS plot that partition the space to support your interpretations/explanations.

Another reason why the actual X and Y axis of the MDS plot have no real meaning is that the MDS representation is insensitive to rotations, translations, reflections, and dilations. i.e. a rotated MDS is the same MDS.

VII.2 PCA

PCA does not establish a direct link between dissimilarity measures and geometric distance.

It is not necessarily true that the ratio of the distances between two pairs of nodes approximately corresponds to the ratio of their buzz-based distances, as is the case for MDS.

“A PCA solution is seldom studied geometrically. Rather, typically only the loadings of the vectors on the components are interpreted.”

VII.3 CA

Distances on CA charts are related to “profile vectors.”

The origin is the average entity (and topic) profile (centroid).

“In the simultaneous representation, the apparent distance between a point j and a point k is not a genuine distance”, so distances between entities and topics to be interpreted with care.

From [2] of Addendum 2 (“Geometric Data Analysis”, Le Roux and Rouanet), p. 49: “Interpreting an axis amounts to finding out what is similar, on the one hand, between all the elements figuring on the right of the origin and, on the other hand between all that is written on the left; and expressing with conciseness and precision, the contrast (or opposition) between the two extremes.”

Addendum 1 shows two examples of the method of FIG. 9 using actual data. One example uses multidimensional scaling, and the other example uses correspondence analysis.

With the above disclosure in mind, and referring to FIG. 9, at step 92 a time frame is specified. It is understood that the time frame may be manually specified by a user, automatically specified by, for example, the server (82 of FIG. 8), or any combination thereof. Examples of times frames are hourly, daily, weekly, monthly, or any other arbitrary period of time, such as every 28 days. The specifying may further include specifying a region, specifying a language, specifying a data source, and the like.

At step 94 a search engine is queried for concepts within the time frame. The concepts include at least one of an entity and a topic. The step of querying further comprises querying a search engine for concepts and pair-wise combinations of concepts. A query may include the conjunction (boolean AND combination) of other queries.

At step 96 the similarity and distances between the concepts are calculated. As disclosed above the calculating comprises computing a distance matrix. In one example computing the distance matrix comprises computing a square symmetric co-reference matrix with co-reference numbers between all possible pairs of concepts. In another example, computing the distance matrix comprises computing a co-reference matrix with co-reference numbers between at least one of possible pairs of concepts, wherein the possible pairs comprise entities-topics, topics-topics, and entities-entities. In yet another example, the distance matrix is at least one of asymmetric and not square. And, in another example, the distance matrix is at least one of symmetric and square. In still another example, the query of step 94 returns a number of articles or documents and the computing in step 96 comprises computing buzz numbers and co-reference numbers from the number of articles or documents.

At step 98 the graph coordinates of the concepts are computed from at least part of the matrix which was computed in step 96. The graph coordinates are computed using one of a multidimensional scaling algorithm, a centric multidimensional scaling algorithm, a principal component analysis algorithm, and a correspondence analysis algorithm.

As indicated by arrow 104, steps 94, 96, and 98 are repeated for additional time frames.

At step 100 consecutive time frames are mapped onto each other. In mapping, at least one of the following transformations are computed: a rotation, a reflection, a dilation, and a sign change. One procedure for mapping time frames is a Procrustes procedure.

At step 102 a dynamic chart is generated showing the relationships between the concepts and how they evolve over the time frames.

The foregoing detailed description has discussed only a few of the many forms that this invention can take. It is intended that the foregoing detailed description be understood as an illustration of selected forms that the invention can take and not as a definition of the invention. It is only the following claims, including all equivalents, that are intended to define the scope of this invention.

Addendum 1: Examples Using MDS and CA

TABLE A1.1
Concepts: types, labels, queries, buzz, and “restricted buzz”
Concepts

| | | | | “Restricted |
|---|---|---|---|---|
| Type | Label | Query | Buzz | buzz” |
| Entity | “Barack Obama” | (((“Barack Obama” OR (obama AND (president | 195561 | / |
| | | OR senator))))) | | |
| Entity | “John McCain” | (((McCain AND (John OR president OR | 162940 | / |
| | | republican OR candidate)))) | | |
| Entity | “Sarah Palin” | (((palin AND (sarah OR president OR candidate | 63301 | / |
| | | OR alaska OR governor OR McCain)))) | | |
| Entity | “Joe Biden” | (((biden AND (joe OR obama OR president OR | 59812 | / |
| | | candidate OR senator)))) | | |
| Topic | “Iraq” | ((iraq OR iraqi OR escalation OR ((“middle east” | | 43277 |
| | | OR este) AND (crisis OR guerra OR war)))) | | |
| Topic | “economy” | ((Economia OR economy OR economics OR | | 67549 |
| | | economic OR dollar OR gastos OR dollars OR | | |
| | | (fiscal AND (policy OR crisis)))) | | |
| Topic | “values” | ((values OR morals OR moral OR valores OR “the | | 35470 |
| | | family” OR abortion OR aborto OR morality)) | | |
| Topic | “environment” | ((environment OR ambiente OR environmental | | 13006 |
| | | OR eco OR “climate change” OR “climate | | |
| | | control”)) | | |
| Topic | “foreign policy” | (((foreign AND policy) OR (politica AND | | 26048 |
| | | extranjero))) | | |
| Topic | “taxes” | ((impuestos OR tax OR taxes OR tariffs OR tariff)) | | 28851 |
| Topic | “big business” | ((“big business” OR corporation OR corporate | | 9918 |
| | | OR corporatión OR (negocios AND grandes))) | | |
| Topic | “energy” | ((energy OR gas OR petrol OR oil OR petroleo | | 45352 |
| | | OR energia OR petróleo)) | | |
| Topic | “health care” | ((health OR medicare OR medicaid OR salud)) | | 29301 |

m = number of entities = 4
n = number of topics = 9
k = m + n = 13
Data window: 2008-08-20 to 2008-09-16
Data source: online news articles

TABLE A1.2
Input for ABM (for 1 region and 1 source): symmetric co-reference
matrix with buzz, restricted buzz and (restricted) co-reference numbers.
Co-reference matrix (symmetric)

| | | | | | | | | | | | | |
|---|---|---|---|---|---|---|---|---|---|---|---|---|
| 195561 | 126617 | 36112 | 53053 | 39356 | 61478 | 31901 | 10637 | 25439 | 26038 | 8625 | 38311 | 26162 |
| 126617 | 162940 | 49182 | 42074 | 36049 | 54944 | 28069 | 9748 | 22680 | 23575 | 7479 | 35807 | 21897 |
| 36112 | 49182 | 63301 | 13702 | 9942 | 16290 | 12487 | 3780 | 6095 | 7982 | 2372 | 13904 | 7093 |
| 53053 | 42074 | 13702 | 59812 | 16230 | 19893 | 12412 | 2729 | 15401 | 6620 | 1849 | 11534 | 8098 |
| 39356 | 36049 | 9942 | 16230 | 43277 | 19989 | 11116 | 3580 | 12819 | 9751 | 2001 | 14831 | 9808 |
| 61478 | 54944 | 16290 | 19893 | 19989 | 67549 | 14296 | 6552 | 13483 | 18533 | 6264 | 24791 | 16718 |
| 31901 | 28069 | 12487 | 12412 | 11116 | 14296 | 35470 | 3378 | 7071 | 7527 | 1714 | 11153 | 8044 |
| 10637 | 9748 | 3780 | 2729 | 3580 | 6552 | 3378 | 13006 | 2368 | 4030 | 1347 | 6988 | 3867 |
| 25439 | 22680 | 6095 | 15401 | 12819 | 13483 | 7071 | 2368 | 26048 | 4849 | 1224 | 9246 | 4798 |
| 26038 | 23575 | 7982 | 6620 | 9751 | 18533 | 7527 | 4030 | 4849 | 28851 | 3956 | 15693 | 10358 |
| 8625 | 7479 | 2372 | 1849 | 2001 | 6264 | 1714 | 1347 | 1224 | 3956 | 9918 | 3704 | 3326 |
| 38311 | 35807 | 13904 | 11534 | 14831 | 24791 | 11153 | 6988 | 9246 | 15693 | 3704 | 45352 | 11021 |
| 26162 | 21897 | 7093 | 8098 | 9808 | 16718 | 8044 | 3867 | 4798 | 10358 | 3326 | 11021 | 29301 |

TABLE A1.3
Square, symmetric dissimilarity/disparity/distance matrix, calculated
from information in the co-reference matrix by applying formula (1).
Distance matrix

| | | | | | | | | | | | | |
|---|---|---|---|---|---|---|---|---|---|---|---|---|
| 0.000 | 0.288 | 0.622 | 0.421 | 0.445 | 0.388 | 0.469 | 0.564 | 0.447 | 0.482 | 0.543 | 0.480 | 0.487 |
| 0.288 | 0.000 | 0.461 | 0.519 | 0.473 | 0.425 | 0.518 | 0.595 | 0.495 | 0.519 | 0.600 | 0.495 | 0.559 |
| 0.622 | 0.461 | 0.000 | 0.777 | 0.807 | 0.751 | 0.725 | 0.825 | 0.835 | 0.799 | 0.862 | 0.737 | 0.823 |
| 0.421 | 0.519 | 0.777 | 0.000 | 0.677 | 0.686 | 0.721 | 0.872 | 0.576 | 0.830 | 0.891 | 0.776 | 0.794 |
| 0.445 | 0.473 | 0.807 | 0.677 | 0.000 | 0.621 | 0.715 | 0.821 | 0.606 | 0.718 | 0.876 | 0.665 | 0.719 |
| 0.388 | 0.425 | 0.751 | 0.686 | 0.621 | 0.000 | 0.693 | 0.700 | 0.641 | 0.542 | 0.638 | 0.543 | 0.591 |
| 0.469 | 0.518 | 0.725 | 0.721 | 0.715 | 0.693 | 0.000 | 0.823 | 0.765 | 0.763 | 0.889 | 0.720 | 0.749 |
| 0.564 | 0.595 | 0.825 | 0.872 | 0.821 | 0.700 | 0.823 | 0.000 | 0.864 | 0.775 | 0.880 | 0.654 | 0.785 |
| 0.447 | 0.495 | 0.835 | 0.576 | 0.606 | 0.641 | 0.765 | 0.864 | 0.000 | 0.823 | 0.915 | 0.721 | 0.826 |
| 0.482 | 0.519 | 0.799 | 0.830 | 0.718 | 0.542 | 0.763 | 0.775 | 0.823 | 0.000 | 0.732 | 0.555 | 0.644 |
| 0.543 | 0.600 | 0.862 | 0.891 | 0.876 | 0.638 | 0.889 | 0.880 | 0.915 | 0.732 | 0.000 | 0.772 | 0.776 |
| 0.480 | 0.495 | 0.737 | 0.776 | 0.665 | 0.543 | 0.720 | 0.654 | 0.721 | 0.555 | 0.772 | 0.000 | 0.690 |
| 0.487 | 0.559 | 0.823 | 0.794 | 0.719 | 0.591 | 0.749 | 0.785 | 0.826 | 0.644 | 0.776 | 0.690 | 0.000 |

TABLE A1.4
Two-dimensional configuration matrix resulting from application
of classical, metric multidimensional scaling on the
distance matrix in Table A1.3.
Multidimensional Scaling (MDS)

| Concept | X | Y |
|---|---|---|
| “Barack Obama” | −0.037 | 0.067 |
| “John McCain” | −0.038 | −0.060 |
| “Sarah Palin” | −0.044 | −0.410 |
| “Joe Biden” | −0.370 | 0.085 |
| “Iraq” | −0.208 | 0.130 |
| “economy” | 0.106 | 0.141 |
| “values” | −0.146 | −0.194 |
| “environment” | 0.184 | −0.281 |
| “foreign policy” | −0.377 | 0.169 |
| “taxes” | 0.260 | 0.084 |
| “big business” | 0.363 | 0.219 |
| “energy” | 0.134 | −0.055 |
| “health care” | 0.174 | 0.105 |

Centric MDS: Example for “Barack Obama” as Focal Concept

TABLE A1.5
mdsCoords: ordinate values of all concepts but the focal concept,
resulting from application of classical, metric MDS on the
distance matrix from Table A1.3 in which row 1 and
column 1 are first removed (focal concept).

| Concept | X |
|---|---|
| “John McCain” | −0.0441802 |
| “Sarah Palin” | −0.0541157 |
| “Joe Biden” | −0.3703048 |
| “Iraq” | −0.2104367 |
| “economy” | 0.1030416 |
| “values” | −0.1489996 |
| “environment” | 0.1801164 |
| “foreign policy” | −0.3781218 |
| “taxes” | 0.2567263 |
| “big business” | 0.3651794 |
| “energy” | 0.1282719 |
| “health care” | 0.1728232 |

| | |
|---|---|
| dMax = | 0.74330 |
| scale = | 0.14196 |
| posOnCirc = | 2.35236 |
| | 2.28238 |
| | 0.05507 |
| | 1.18121 |
| | 3.38943 |
| | 1.61399 |
| | 3.93236 |
| | 0.00000 |
| | 4.47202 |
| | 5.23599 |
| | 3.56716 |
| | 3.88099 |
| angles = | −1.30517 |
| | −1.23518 |
| | 0.99213 |
| | −0.13402 |
| | −2.34223 |
| | −0.56679 |
| | −2.88516 |
| | 1.04720 |
| | −3.42482 |
| | −4.18879 |
| | −2.51996 |
| | −2.83379 |

| | Concept | X | Y |
|---|---|---|---|
| centricCoordinates = | “Barack Obama” | 0.00000 | 0.00000 |
| | “John McCain” | 0.26252 | −0.96493 |
| | “Sarah Palin” | 0.32935 | −0.94421 |
| | “Joe Biden” | 0.54691 | 0.83719 |
| | “Iraq” | 0.99103 | −0.13361 |
| | “economy” | −0.69716 | −0.71691 |
| | “values” | 0.84363 | −0.53693 |
| | “environment” | −0.96730 | −0.25363 |
| | “foreign policy” | 0.50000 | 0.86603 |
| | “taxes” | −0.96016 | 0.27946 |
| | “big business” | −0.50000 | 0.86603 |
| | “energy” | −0.81293 | −0.58236 |
| | “health care” | −0.95300 | −0.30297 |

After application of the exponential multiplier to the coordinates (to pull non-centric concepts the center), this becomes:

TABLE A1.5
Two-dimensional configuration matrix resulting from centric
MDS. “Barack Obama” is the focal concept.

| Concept | X | Y |
|---|---|---|
| “Barack Obama” | 0.00000 | 0.00000 |
| “John McCain” | 0.03764 | 0.13834 |
| “Sarah Palin” | 0.18927 | −0.54260 |
| “Joe Biden” | 0.24236 | 0.37100 |
| “Iraq” | 0.54186 | −0.07306 |
| “economy” | −0.27149 | −0.27918 |
| “values” | 0.51715 | −0.32914 |
| “environment” | −0.82167 | −0.21544 |
| “foreign policy” | 0.33844 | 0.58620 |
| “taxes” | −0.64398 | 0.18743 |
| “big business” | −0.43803 | 0.75870 |
| “energy” | −0.45166 | −0.32356 |
| “health care” | −0.63796 | −0.20281 |

Stability of ABMs Over Time

In case of MDS, the temporal mapping is done by the “Procrustes procedure”.

For example, Table A1.6 contains the coordinates for a subsequent time frame, which are to be mapped on the coordinates of Table A1.4 (previous time frame).

TABLE A1.6
coordinates_t2: ABM coordinates of a later time frame.

| Concept | X | Y |
|---|---|---|
| “Barack Obama” | −0.040000 | 0.070000 |
| “John McCain” | −0.040000 | −0.060000 |
| “Sarah Palin” | −0.040000 | −0.410000 |
| “Joe Biden” | −0.370000 | 0.080000 |
| “Iraq” | −0.210000 | 0.130000 |
| “economy” | 0.110000 | 0.140000 |
| “values” | −0.150000 | −0.190000 |
| “environment” | 0.180000 | −0.280000 |
| “foreign policy” | −0.380000 | 0.170000 |
| “taxes” | 0.260000 | 0.080000 |
| “big business” | 0.360000 | 0.220000 |
| “energy” | 0.130000 | −0.050000 |
| “health care” | 0.170000 | 0.110000 |

TABLE A1.7
optimal_coordinates_t2: ABM coordinates of
the later time frame (cf. Table A1.6) ‘mapped’ onto the
previous time frame (Table A1.4) by the procrustes procedure.
(Allowed transformations for an MDS ABM: rotations,
reflections, and dilations)

| Concept | X | Y |
|---|---|---|
| “Barack Obama” | −0.036903 | 0.067850 |
| “John McCain” | −0.036860 | −0.048182 |
| “Sarah Palin” | −0.039172 | −0.362750 |
| “Joe Biden” | −0.370051 | 0.092506 |
| “Iraq” | −0.210448 | 0.109146 |
| “economy” | 0.105558 | 0.132463 |
| “values” | −0.134775 | −0.185817 |
| “environment” | 0.185918 | −0.313082 |
| “foreign policy” | −0.384220 | 0.153858 |
| “taxes” | 0.256170 | 0.070392 |
| “big business” | 0.362573 | 0.273206 |
| “energy” | 0.131387 | −0.079863 |
| “health care” | 0.170822 | 0.090273 |

If the set of concepts that are present in timeframe t1 is not exactly the same as in timeframe t2, then the procrustes procedure only considers the concepts that are present in both timeframes (intersection). (For example, concepts might have zero buzz in one of the timeframes, or new concepts could be added to the brand map)

Principal Component Analysis (PCA)

TABLE A1.8
Contingency table ‘contTable’ (=sub-part of co-reference matrix in
Table A1.2) with column sums, row sums and total sum indicated.
Correspondence Analysis (CA)

| | | | | | | | | | | Row |
|---|---|---|---|---|---|---|---|---|---|---|
| | | | | | foreign | | big | | health | sums |
| | Iraq | economy | values | environment | policy | taxes | business | energy | care | (row Sum) |
| Barack | 39356 | 61478 | 31901 | 10637 | 25439 | 26038 | 8625 | 38311 | 26162 | 267947 |
| Obama | | | | | | | | | | |
| John | 36049 | 54944 | 28069 | 9748 | 22680 | 23575 | 7479 | 35807 | 21897 | 240248 |
| McCain | | | | | | | | | | |
| Sarah | 9942 | 16290 | 12487 | 3780 | 6095 | 7982 | 2372 | 13904 | 7093 | 79945 |
| Palin | | | | | | | | | | |
| Joe | 16230 | 19893 | 12412 | 2729 | 15401 | 6620 | 1849 | 11534 | 8098 | 94766 |
| Biden | | | | | | | | | | |
| Column | 101577 | 152605 | 84869 | 26894 | 69615 | 64215 | 20325 | 99556 | 63250 | totSum = |
| sums | | | | | | | | | | 682906 |
| (colSum) | | | | | | | | | | |

Octave code to compute CA according to [2] (“Geometric Data Analysis”, Le Roux and Rouanet):

```
nEntities= m;
nNodes= k;
validBuzzMatrixRowsCols= [1:nNodes];
rowSum= sum(contTable,2);
colSum = sum(contTable,1);
totSum= sum(rowSum);
Dr= diag(rowSum);
Dc= diag(colSum);
E= rowSum*colSum/totSum; % matrix of expected values under
the independence model
DrPow_05= Dr\hat{ }(−0.5);
DcPow_05= Dc\hat{ }(−0.5);
DrPow_pos05= Dr\hat{ }(0.5);
DcPow_pos05= Dc\hat{ }(0.5);
M= DrPow_05  * contTable * DcPow_05;
M0= M − 1/totSum*( DrPow_pos05 *
ones(size(contTable,1),1) * ones(1,size(contTable,2)) * DcPow_pos05);
[u, s, v] = svd(M0);
R= sqrt(totSum) * DrPow_05 * u * s;
if size(v,2) ~= size(s,1)
  sss= s′;
else
  sss= s;
end
C= sqrt(totSum) * DcPow_05 * v * sss;
coords2D = zeros(nNodes, 2);
coords2D( [intersect(validBuzzMatrixRowsCols,[1:nEntities])],
1:2)= R(:,1:2);
coords2D( [intersect(validBuzzMatrixRowsCols,[nEntities+1:nNodes])],
1:2)= C(:,1:2);
```

TABLE A1.9
Two-dimensional configuration matrix resulting from CA.
Matrix of expected values under the independence model (E) =

| | | | | | | | | |
|---|---|---|---|---|---|---|---|---|
| 3.9855e+04 | 5.9877e+04 | 3.3299e+04 | 1.0552e+04 | 2.7314e+04 | 2.5196e+04 | 7.9748e+03 | 3.9062e+04 | 2.4817e+04 |
| 3.5735e+04 | 5.3687e+04 | 2.9857e+04 | 9.4614e+03 | 2.4491e+04 | 2.2591e+04 | 7.1504e+03 | 3.5024e+04 | 2.2252e+04 |
| 1.1891e+04 | 1.7865e+04 | 9.9353e+03 | 3.1484e+03 | 8.1495e+03 | 7.5174e+03 | 2.3794e+03 | 1.1655e+04 | 7.4044e+03 |
| 1.4096e+04 | 2.1177e+04 | 1.1777e+04 | 3.7320e+03 | 9.6604e+03 | 8.9110e+03 | 2.8205e+03 | 1.3815e+04 | 8.7771e+03 |

M =

| | | | | | | | | |
|---|---|---|---|---|---|---|---|---|
| 0.238555 | 0.304026 | 0.211546 | 0.125305 | 0.186262 | 0.198502 | 0.116874 | 0.234566 | 0.200963 |
| 0.230763 | 0.286950 | 0.196572 | 0.121271 | 0.175373 | 0.189803 | 0.107028 | 0.231528 | 0.177633 |
| 0.110327 | 0.147483 | 0.151596 | 0.081521 | 0.081701 | 0.111403 | 0.058844 | 0.155851 | 0.099748 |
| 0.165422 | 0.165421 | 0.138402 | 0.054057 | 0.189614 | 0.084862 | 0.042130 | 0.118746 | 0.104597 |
| . . . | | | | | | | | |

| | Concept | X | Y |
|---|---|---|---|
| coords2D = | “Barack Obama” | −0.0243545 | 0.0271031 |
| | “John McCain” | −0.0272003 | 0.0229095 |
| | “Sarah Palin” | −0.1183412 | −0.1180778 |
| | “Joe Biden” | 0.2376518 | −0.0351015 |
| | “Iraq” | 0.0731092 | 0.0307280 |
| | “economy” | −0.0125957 | 0.0416491 |
| | “values” | −0.0080728 | −0.0993985 |
| | “environment” | −0.1202766 | −0.0237781 |
| | “foreign policy” | 0.2449037 | −0.0154220 |
| | “taxes” | −0.1008656 | 0.0231540 |
| | “big business” | −0.1255398 | 0.0620026 |
| | “energy” | −0.0816193 | −0.0395712 |
| | “health care” | −0.0233801 | 0.0294757 |

Addendum 2: Reference Material

The following reference material is hereby incorporated by reference:

Lee G. Cooper, “A Review of Multidimensional Scaling in Marketing Research,”

Applied Psychological Measurement, Vol. 7, No. 4, 427-450 (1983)

http://apm.sagepub.com/cgi/content/abstract/7/4/427

C. L. Bentley, M. O. Ward, “Animating multidimensional scaling to visualize N-dimensional data sets,” infovis, pp. 72, 1996 IEEE Symposium on Information Visualization (Info Vis '96), 1996

http://www2.computer.org/portal/web/csdl/doi/10.1109/INFVIS.1996.559 223

[1] Modern Multidimensional Scaling. Theory and Applications.

Series: Springer Series in Statistics

Borg, Ingwer, Groenen, Patrick J. F.

Originally published in the series: Springer Series in Statistics

2nd ed., 2005, XXII, 614 p. 176 illus., Hardcover

ISBN: 978-0-387-25150-9

[2] Geometric Data Analysis

From Correspondence Analysis to Structured Data Analysis

Le Roux, Brigitte, Rouanet, Henry

2005, XI, 475 p., Hardcover

ISBN: 978-1-4020-2235-7

[3] Applied Multivariate Techniques

Subhash Sharma

1995, 493 p., Hardcover

John Wiley & Sons Inc

ISBN-10: 0471310646

ISBN-13: 9780471310648

Addendum 3: XML Schema Definition for transferring BM data

```
<?xml version=“1.0” encoding=“UTF-8”?>
<xs:schema xmlns:xs=“http://www.w3.org/2001/XMLSchema” elementFormDefault=“qualified”>
<!-- xmlns=“http://www.attentio.com”
  targetNamespace=“http://www.attentio.com” -->
  <xs:annotation>
    <xs:appinfo>Attentio Note</xs:appinfo>
    <xs:documentation xml:lang=“en”>
      This Schema defines a series of plots.
    </xs:documentation>
  </xs:annotation>
  <xs:simpleType name=“nodeLabelType”>
    <xs:restriction base=“xs:string”>
      <xs:whiteSpace value=“collapse”/>
    </xs:restriction>
  </xs:simpleType>
  <xs:simpleType name=“nodeKindType”>
    <xs:restriction base=“xs:string”>
      <xs:enumeration value=“Entity”/>
      <xs:enumeration value=“Topic”/>
      <xs:enumeration value=“unspecified”/>
    </xs:restriction>
  </xs:simpleType>
  <xs:simpleType name=“buzzSizeType”>
    <xs:restriction base=“xs:integer”>
      <xs:minInclusive value=“−1”/>
    </xs:restriction>
  </xs:simpleType>
  <xs:simpleType name=“normalizedBuzzSizeType”>
    <xs:restriction base=“xs:float”>
      <xs:minInclusive value=“0.0”/>
      <xs:maxInclusive value=“100.0”/>
    </xs:restriction>
  </xs:simpleType>
  <xs:simpleType name=“coOccNumberType”>
    <xs:restriction base=“xs:integer”>
      <xs:minInclusive value=“−1”/>
    </xs:restriction>
  </xs:simpleType>
  <xs:simpleType name=“floatList”>
    <xs:list itemType=“xs:float”/>
  </xs:simpleType>
  <xs:simpleType name=“buzzSizeList”>
    <xs:list itemType=“buzzSizeType”/>
  </xs:simpleType>
  <xs:complexType name=“axisQType”>
    <xs:attribute name=“ax” type=“xs:positiveInteger” use=“required”/>
    <xs:attribute name=“Q” type=“xs:string” use=“required”/>
  </xs:complexType>
  <xs:complexType name=“nodeType”>
    <xs:sequence>
      <xs:element name=“co” type=“floatList”/>
      <xs:element name=“c” type=“floatList” minOccurs=“0” maxOccurs=“unbounded”/>
      <xs:element name=“bz” type=“buzzSizeType” minOccurs=“0”/>
      <xs:element name=“nrmBz” type=“normalizedBuzzSizeType” minOccurs=“0”/>
      <xs:element name=“s” type=“buzzSizeList” minOccurs=“0”/>
      <xs:element name=“query” type=“xs:string” minOccurs=“0”/>
    </xs:sequence>
    <xs:attribute name=“label” type=“nodeLabelType”/>
    <xs:attribute name=“ID” type=“nodeLabelType” use=“required”/>
    <xs:attribute name=“v” type=“xs:boolean” default=“true”/>
  </xs:complexType>
  <xs:complexType name=“coOccType”>
    <xs:attribute name=“u” type=“nodeLabelType” use=“required”/>
    <xs:attribute name=“v” type=“nodeLabelType” use=“required”/>
    <xs:attribute name=“n” type=“coOccNumberType” use=“required”/>
  </xs:complexType>
  <xs:attributeGroup name=“plotAttrGrp”>
    <xs:attribute name=“type” type=“xs:string”/>
    <xs:attribute name=“ti” type=“xs:string”/>
    <xs:attribute name=“dim” type=“xs:positiveInteger” default=“2”/>
    <xs:attribute name=“dataStartDate” type=“xs:date”/>
    <xs:attribute name=“dataEndDate” type=“xs:date”/>
    <xs:attribute name=“dateGen” type=“xs:date”/>
    <xs:attribute name=“timeGen” type=“xs:time”/>
    <xs:attribute name=“coordsComputationTime” type=“xs:duration”/>
    <xs:attribute name=“xLab” type=“xs:string”/>
    <xs:attribute name=“yLab” type=“xs:string”/>
    <xs:attribute name=“zLab” type=“xs:string”/>
    <xs:attribute name=“Q” type=“xs:string”/>
  </xs:attributeGroup>
  <xs:complexType name=“plotType”>
    <xs:sequence>
      <xs:element name=“Q” type=“axisQType” minOccurs=“0” maxOccurs=“unbounded”/>
      <xs:element name=“n” type=“nodeType” maxOccurs=“unbounded”/>
      <xs:element name=“cr” type=“coOccType” maxOccurs=“unbounded” minOccurs=“0”/>
      <xs:any minOccurs=“0”/>
    </xs:sequence>
    <xs:attributeGroup ref=“plotAttrGrp”/>
    <xs:anyAttribute/>
  </xs:complexType>
  <xs:complexType name=“nodeIDsAndLabelsType”>
    <xs:attribute name=“ID” type=“xs:string” use=“required”/>
    <xs:attribute name=“label” type=“nodeLabelType” use=“required”/>
    <xs:attribute name=“kind” type=“nodeKindType” default=“unspecified”/>
  </xs:complexType>
  <xs:complexType name=“allNodeIDsAndLabelsType”>
    <xs:sequence>
      <xs:element name=“nodeID” type=“nodeIDsAndLabelsType” maxOccurs=“unbounded”/>
    </xs:sequence>
  </xs:complexType>
  <xs:complexType name=“plotSeriesType”>
    <xs:sequence>
      <xs:element name=“NodeIDsAndLabels” type=“allNodeIDsAndLabelsType” maxOccurs=“1”/>
      <xs:element name=“Plot” type=“plotType” maxOccurs=“unbounded”/>
      <xs:any minOccurs=“0”/>
    </xs:sequence>
    <xs:attribute name=“seriesTitle” type=“xs:string” default=“”/>
    <xs:attribute name=“projectName” type=“xs:string” default=“”/>
    <xs:attribute name=“projectLabel” type=“xs:string” default=“”/>
    <xs:attribute name=“projectID” type=“xs:string” default=“”/>
    <xs:attribute name=“alg” type=“xs:string” default=“”/>
    <xs:attribute name=“version” type=“xs:positiveInteger” default=“1”/>
    <xs:attribute name=“projectStartDate” type=“xs:string” default=“”/>
    <xs:attribute name=“projectEndDate” type=“xs:string” default=“”/>
    <xs:attribute name=“projectReportFreq” type=“xs:float” default=“24”/>
    <xs:attribute name=“srcUsrLab” type=“xs:string” default=“”/>
    <xs:attribute name=“regionUsrLab” type=“xs:string” default=“”/>
    <xs:attribute name=“entitiesPresLabel” type=“xs:string” default=“Brands”/>
    <xs:attribute name=“topicsPresLabel” type=“xs:string” default=“Topics”/>
    <xs:anyAttribute/>
  </xs:complexType>
  <xs:element name=“PlotSeries” type=“plotSeriesType”/>
</xs:schema>
```

What is claimed is:

1. A method for monitoring online media and charting the results to facilitate human pattern detection comprising:
(a) specifying a time frame;
(b) querying a search engine for concepts within the time frame;
(c) calculating similarity and distances between the concepts, wherein the calculating comprises computing a distance matrix;
(d) computing graph coordinates of the concepts from at least part of the matrix in (c);
(e) repeating (b), (c) and (d) for at least one more time frame;
(f) mapping consecutive time frames onto each other; and
(g) generating a dynamic chart of the relationships between the concepts and how they evolve over the time frames.

2. The method of claim 1 wherein the step of specifying further comprises specifying a region.

3. The method of claim 1 wherein the step of specifying further comprises specifying a language.

4. The method of claim 1 wherein the step of specifying further comprises specifying a data source.

5. The method of claim 1 wherein the step of querying comprises querying a search engine for concepts and pair-wise combinations of concepts.

6. The method of claim 1 wherein computing a distance matrix in (c) comprises computing a square symmetric co-reference matrix with co-reference numbers between all possible pairs of concepts.

7. The method of claim 1 wherein computing a distance matrix in (c) comprises computing a co-reference matrix with co-reference numbers between at least one of possible pairs of concepts, wherein the possible pairs comprise entities-topics, topics-topics, and entities-entities.

8. The method of claim 1 wherein the distance matrix is at least one of asymmetric, and not square.

9. The method of claim 1 wherein the distance matrix is at least one of symmetric, and square.

10. The method of claims 1 wherein the query in (b) returns a number of articles or documents and the step of computing in (c) comprises computing buzz numbers and co-reference numbers from the number of articles or documents.

11. The method of claim 1 wherein the computing in (d) comprises computing using one of: a multidimensional scaling algorithm, a centric multidimensional scaling algorithm, a principal component analysis algorithm, and a correspondence analysis algorithm.

12. The method of claim 1 wherein the mapping in (f) comprises mapping using a procrustes procedure.

13. The method of claim 1 wherein the mapping in (f) comprises computing at least one of the following transformations: a rotation, a reflection, a dilation, and a sign change.

14. The method of claim 1 wherein the concepts include at least one of: an entity, and a topic.

15. A computer program product comprising a computer readable medium including a computer readable program, wherein the computer readable program when executed on a computer causes the computer to:
(a) query a search engine for concepts within a time frame;
(b) calculate similarity and distances between the concepts, wherein the calculating comprises computing a distance matrix;
(c) compute graph coordinates of the concepts from at least part of the matrix in (b);
(e) repeat (a), (b) and (c) for at least one more time frame;
(d) map consecutive time frames onto each other; and
(e) generate a dynamic chart of the relationships between the concepts and how they evolve over the time frames.

16. The computer program product of claim 15 wherein at least some of the computer readable program is executed on a server.

17. The computer program product of claim 15 wherein at least some of the computer readable program is executed on a client computer.

18. A system for monitoring online media and charting the results to facilitate human pattern detection comprising:
(a) means for specifying a time frame;
(b) means for querying a search engine for concepts within the time frame;
(c) means for calculating similarity and distances between the concepts, wherein the means for calculating comprises means for computing a distance matrix;
(d) means for computing graph coordinates of the concepts from at least part of the matrix in (c);
(e) means for repeating (b), (c) and (d) for at least one more time frame;
(f) means for mapping consecutive time frames onto each other; and
(g) means for generating a dynamic chart of the relationships between the concepts and how they evolve over the time frames.
